(19) United States
(12) Patent Application Publication
(10) Pub. No.: US 2008/0281010 A1
(43) Pub. Date: Nov. 13, 2008

(54) Fine cell foamed polyolefin film or sheet

(75) Inventors: John Lefas, Houston, TX (US); Salvatore D'Uva, Brantford (CA); Arthur Tinson, Hamilton (CA)

Correspondence Address: JACKSON WALKER LLP, 901 MAIN STREET, SUITE 6000, DALLAS, TX, 75202-3797, US

(73) Assignee: Ingenia Polymers Inc., Houston, TX (US)

(21) Appl. No.: 12/079,813

(22) Filed: Mar. 28, 2008

Related U.S. Application Data
(60) Provisional application No. 60/922,857, filed on Apr. 11, 2007.

(51) Int. Cl. C08J 9/06; C08J 9/228

(52) U.S. Cl. 521/97; 521/149; 521/142; 521/146

(57) ABSTRACT

Foamed film compositions using chemical blowing agents and produced by continuous blown film extrusion or cast film extrusion of polymer foams. The composition has small cell size and is suitable for the production of thin film articles. The articles may be monolayer or multilayered structures.

This application claims priority to U.S. Provisional Patent Application Ser. No. 60/922,857, entitled “FINE CELL FOAMED POLYOLEFIN FILM OR SHEET” filed on Apr. 11, 2007, the entire content of which is hereby incorporated by reference.

This invention relates to both polyolefin and polystyrene foams, more specifically to making foamed film products by blown film process or cast film process employing chemical blowing agents. Thermoplastics foams are produced using commonly available, environmentally friendly ingredients. This allows for ease of use, ease of handling, and complete recyclability.

### BACKGROUND

Over the past few decades, polymeric foams have garnered rapid growth in the plastics industry. The many benefits of polymeric foams include weight reduction, superior insulating abilities, exceptional strength to weight ratio and energy absorption (shock, vibration and sound). Foams have been prepared in a variety of polymers such as polyurethane, polystyrene, polyvinyl chloride, epoxys and polyolefins. Polymeric foams have been used in a wide variety of applications including automotive, packaging, insulation, flotation, furniture, bedding, textiles and toys to name a few. Several different processing techniques have been used to produce foams including compression molding, extrusion, injection molding, rotational molding and cast film. Polyolefins are generally considered to be tough, flexible, abrasion resistant, and chemically resistant. As such, polyolefin foams tend to inherit such properties lending themselves to be very useful for a wide variety of applications. Polyolefin foams are generally divided into two categories. The first category is low density foams which are typically less than 240 kg/m³, and the second category is high density foams which are typically greater than 240 kg/m³.

This invention relates to both polyolefin and polystyrene foams. Polystyrene foams are widely use in applications such as food packaging. They can be used to produce rigid foamed sheet with good shape retention. However, some of their uses may be limited due to the inherit brittleness of such articles as well as low service temperature and low chemical resistance of polystyrene for this type of application. Polyethylene foams can offer advantages of improved overall toughness and chemical resistance and thus offer the potential for use in a broader scope of areas.

Generally, there has been limited success in industry in producing very thin foamed polyolefin films with closed cell structures. Foamed film or sheet has various unique attributes hence is used in various niche applications, as reviewed by the article Foamed Film Find New Niches (Plastics Technology, February, 2002). If very fine celled polyolefin foams can be made into thin films or layered thin film structures utilizing commonly available commercial polyolefin film-making equipment, then this may present numerous new application areas for the use of such films. Likewise, the same may exist for the family of polystyrenic films.

Techniques are known in the art to produce foamed articles.

U.S. Pat. No. 4,251,584 discloses a process in which extruded foamed film or sheet is produced using physical blowing agent. Cell size is around 300 to 800 microns.

U.S. Pat. No. 6,103,153 discloses compositions and method for the production of polyproplylene foam by rotomolding.

U.S. Pat. No. 4,251,584 discloses a polyethylene based foamed film with a required minimum amount of an ethylene polymer containing polar groups. Additionally, a vinyl halide is employed as a blowing agent. The foam film of this invention is relatively thick. The thinnest film illustrated is 0.28 mm (11 mil) thickness and the average cell size as described in the examples is 0.7 mm (700 microns).

U.S. Pat. No. 6,521,675 discloses a foamed polypropylene sheet with improved surface appearance and having a density in the range of 400 to 800 kg/m³. The sheet produce is typically in the range of 35 to 53 mil thickness with average cell sizes in the range of 90 to 210 microns.

### SUMMARY OF THE INVENTION

The present invention relates to making foamed film products by blown film process or cast film process employing chemical blowing agents. Thermoplastics foams are produced using commonly available, environmentally friendly ingredients. This allows for ease of use, ease of handling, and complete recyclability.

This invention is useful in that it allows for the use of commodity polyolefin plastics such as low density polyethylene, high density polyethylene or linear low density polyethylene, all of which are very commonly available on a commercial scale. Since polyethylene is a commodity plastic material, this low cost base polymer can be utilized for the production of value-added foamable plastics material.

This invention illustrates a composition and methods for making very fine cell foamed blown film or cast film by utilizing a chemical blowing agent additive or a chemical blowing agent additives masterbatch in polyethylene or in polystyrene. Optionally an additional nucleating agent can be employed.

The film may be a monolayer or a multilayer film in which at least one of the layers formed contains fine or small cell sizes with an average cell size of equal to or less than about 60 microns in diameter, and preferably an average cell size of less than 50 microns in the foamed polyethylene layer. Most preferably, an average cell size of less than 30 microns in the foamed polyethylene layer is obtained. Such small cell sizes will allow for a monolayer film or a multilayer film to be “thin”. The film thickness is less than 10 mil, preferably less than 6 mil and most preferably less than about 4 mils. In the case of a multilayered film, the foamed layer thickness is less than 10 mil, preferably less than 6 mil and most preferably less than about 4 mils.

### DETAILED DESCRIPTION OF THE PREFERRED EMBODIMENTS

The term “melt index” refers to the melt flow rate of the polyethylene measured according to ASTM D1238 at a temperature of 190° C. with a weight of 2.16 kg and is expressed as g/10 minutes. The term “melt flow rate” refers to the melt flow rate of polystyrene measured according to ASTM D1238 at a temperature of 200° C. with a weight of 5.0 kg and is expressed in g/10 minutes.

The term “foam density” refers to the density, which may be measured according to ASTM D792 where specimens are measured on a Scientech ZSA210 instrument which is designed to measure density according this procedure.

The term “cell size” refers to the average diameter at the widest point of the foam cells created. Samples are prepared by freezing in liquid nitrogen and fracturing. A thin gold coating is evaporated on to the fractured surface. The samples are then analyzed under an Elemental Scanning Electron Microscope (“ESEM”) and digital images were taken. These images were then used to measure the individual cell diameters from the images. An arithmetic average of the measured cells was then calculated and reported as the “cell size”.

The percentage, represented by the symbol “%,” refers to weight percent.

Suitable polyethylene and polystyrene foamed film articles were made by the compositions described below.

In a preferred embodiment, the polyethylene and polystyrene foamed film articles are produced using a blowing agent masterbatch. In a preferred embodiment, an inorganic blowing agent is blended with a metal bicarbonate, an organic acid, an organic surfactant and a low melt temperature carrier resin in a mixer to give a blowing agent masterbatch. The blowing agent masterbatch is mixed, removed from the mixer, and cold pressed into a sheet. The sheet may be cut into pieces.

The blowing agent masterbatch may be used for foaming a polymeric resin. The blowing agent masterbatch and the polymeric resin are added to a blown film extruder to give a foamed film.

A blowing agent may be used, which generates a gas suitable to foam the polymeric resin. The blowing agent employed was an endothermic chemical blowing agent. Most preferably an inorganic chemical blowing agent is used in combination with a chemical blowing agent modifier, such as an organic acid and surfactant, either as powder blend, pelletized blend, or as a masterbatch formulation. The inorganic agent used as a blowing agent may include, but not be limited to, metal bicarbonates, and preferably sodium bicarbonate. It was found that a very small particle size sodium bicarbonate will produce more beneficial results.

When a blowing agent masterbatch was employed, it could comprise of about 40-95 parts of a low melting point polymer carrier resin, about 1-20 parts of an organic surfactant, about 2-30 parts of a chemical blowing agent modifier such as an organic acid and about 2-50 parts of an inorganic blowing agent. Preferably, the blowing agent masterbatch would consist of about 60-90 parts of a low melting point polymer carrier resin, about 2-15 parts of an organic surfactant, about 5-20 parts of chemical blowing agent modifier, such as an organic acid and about 5-20 parts of an inorganic blowing agent. Most preferably, the blowing agent masterbatch would consist of about 70-80 parts of a low melting point polymer carrier resin, about 2-10 parts of an organic surfactant, about 5-15 parts of chemical blowing agent modifier, such as an organic acid and about 5-15 parts of an inorganic blowing agent.

Although not wanting to be bound by any theory, it is believed that the organic surfactant may act as a lubricant to help disperse the chemical blowing agent and chemical blowing agent modifier, such as an organic acid. In addition it can act as a cell stabilizer which can minimize the potential for cell coalescence.

The low melt temperature carrier resin used herein can be any materials falling within the scope of having a melting point range of about 40-105° C., most preferably a melting point range of less than about 100° C. The carrier resin may include acrylate copolymers including vinyl, butyl, ethyl, and methyl acrylates. The carrier resin can also include low melting polyolefins. The organic surfactant used are long chain fatty acid amides such as behenamide, erucamide, oleamide, stearamide, oleyl palmitamide, stearyl erucamide, ethylene bis-stearamide and ethylene bis-oleamide. The organic surfactant may also include glycerol esters such as glycerol monostearate. The organic acid is used to alter the decomposition behavior of the inorganic chemical blowing agent and can help to optimize the temperature and rate at which the gas is released from the chemical blowing agent. If the chemical blowing agent releases gas before the polymer is molten, the gas may escape from the polymer and extruder and so not enough gas will remain to dissolve into the polymer melt. If the release of gas from the chemical blowing agent is delayed for too long or occurs at too high of a temperature, then there may not be enough residence time and mixing available to effectively dissolve and mix the gas which is generated. Examples of organic acids include citric, stearic, lactic, tartaric, oleic, phthalic and maleic acids. Additionally, other chemical decomposition modifying agents can be employed such as monosodium citrate, potassium sodium tartate, monocalcium phosphate, sodium aluminum sulfate and the like can be used in place of the organic acid if required to help optimize the decomposition temperature of the chemical blowing agent.

The blowing agent additives, which include the chemical blowing agent, the chemical blowing agent modifier, such as an organic acid and the organic surfactant, can be processed using conventional extrusion or melt mixing methods including a Brabender mixer, Banbury mixer, single screw extruders, twin screw extruders or other mixing devices which melt the carrier resin and possibly other additives present depending on the processing temperature so long as the processing temperature stays below the decomposition temperature of the chemical blowing agent being processed. The blowing agent additives can also be introduced utilizing other methods as well. They can be fed individually and directly to the film blowing or film extruding machine together with polymer resin to be foamed. They can be preblended together and then fed directly to the film blowing or film extruding machine together with polymer resin to be foamed. They can be preblended together with the polymer resin to be foamed and then fed to the film blowing or film extruding machine. They may also be preblended and pelletized and fed as an additive pellet to the film blowing or film extruding machine together with the polymeric resin to be foamed. These blowing agent additives can be pelletized using equipment such as a California Pellet Mill (CPM) or other devices which will form the additive blend into a pellet without initiating or causing and chemical change to the ingredients prior to being fed into the film extrusion line. If required, a binder can be used to make a blowing agent additive pellet which is robust enough to be handled and fed without generating unnecessary dust. The binder may consist of various substances including things such as a wax, a paraffinic oil, an aromatic oil or a glycerol monocarboxylic acid ester and the like. The following are examples of suitable binders; polyethylene, polypropylene, olefinic copolymers, ethylene/vinyl acetate copolymers, polyethylene glycol, polypropylene glycol, glycerol monostearate. In addition to these techniques, it is also possible to first feed the polymer resin to be foamed and then feed the blowing agent additives downstream from the polymer feed in the extruder being used to make the foamed film article. The blowing agent additives can be in powder form, powder preblend, pellet preblend, or masterbatch, all of which are described above, when fed downstream as well. The blowing agent additives whether fed as individual powders, a powder preblend of additives or as a pelletized blowing agent additive blend may comprise; 20-60 parts of the chemical blowing agent, 10-50 parts of the chemical blowing agent modifier, such as an organic acid, and 1-30 parts of an organic surfactant. Optionally, when this is prepared as a pelletized blowing agent additive blend a binder may be present at 0-30 parts. The blowing agent additives whether fed as individual powders, a powder preblend of additives or as a pelletized blowing agent additive blend preferably may comprise; 25-55 parts of the chemical blowing agent, 20-40 parts of the chemical blowing agent modifier, such as an organic acid, and 2-20 parts of an organic surfactant. Optionally, when this is prepared as a pelletized blowing agent additive blend a binder may be present at 0-30 parts.

Additionally, a cell nucleating agent can also be used. A nucleating agent can be defined herein as a chemical substance which when incorporated in the composition for producing the foamed article form nuclei for the growth of cells in the polymer melt. This can include many different substances most of which are non-melting fine powders which are present. Typically, a nucleating agent for foaming will be a chemical such as silica, precipitated silica, talc, calcium carbonate, precipitated calcium carbonate, mica, titanium dioxide, nanosized titanium dioxide, clay, nanoclay, metal stearates, carbon black, sodium aluminum silicate, aluminum oxide and the like.

This nucleating agent can be introduced in combination with the blowing agent additives or separately from the blowing agent additives. In either case all of the above mentioned techniques for introducing the blowing agent additives may also be utilized for introducing the nucleating agent as well.

In one particular preferred embodiment of the present invention a small particle size of the chemical blowing agent is employed. A chemical blowing agent such as sodium bicarbonate will leave an inorganic residue upon decomposition and release of the blowing gas. This residue may act as a nucleation site for cell formation. Additionally, the smaller particle size will have a larger total surface area and can offer further benefits. When decomposition occurs, the decomposition gas is more uniformly distributed within the polymer as it is released from the chemical blowing agent and thus may more readily dissolve into the polymer to be foamed. Additionally, when an additive such as an organic acid is employed to control the decomposition temperature and kinetics such that the gas is released when the polymer is sufficiently molten so that the dissolution is again optimized and efficient use of the gas is achieved.

The films of this invention can be less than 5 mil in thickness and have an average cell size of less that 60 microns. Preferably the films will have foam cells with an average size of less than 50 microns and most preferable less than 30 microns average cell size.

The film blowing or film extrusion machine can be equipment typically used in industry such as blown film extruders, cast film extruders, extrusion coating extruders and other equipment suitable for producing thin film in a continuous process. In some cases, the film forming equipment is capable of producing multiple layers of film extrudate continuously. For example, in a simple 3 layer structure such as an A/B/A layer structure, it may be beneficial to have a foamed inner layer (B). This may offer a film with reduced weight as well as other possible improvements such as thermal resistance. Similarly, it may be possible to have more than one foamed layer in structures that contain multiple layers.

The final foamed film or foamed film layer, in the case of a multilayered film, will essentially consist of polymeric resin and a chemical blowing agent. The polymeric resin may be a polyolefin such as low density polyethylene (LDPE), linear low density polyethylnene (LLDPE) or high density polyethylene (HDPE) or other alpha olefin polymers or copolymers. The polymeric resin may also be a polystyrene. The chemical blowing agent is preferably an inorganic blowing agent and most preferable a metal bicarbonate. The chemical blowing agent is added at 0.1% to 4.0% of the total composition, preferably it is added at 0.2% to 3% and most preferably at 0.5 to 2%. In addition, the film may comprise a chemical blowing agent modifier which can be used to alter the decomposition behavior of the chemical blowing agent being employed. The chemical blowing agent modifier is added at 0.1% to 4% of the total composition, preferably it is added at 0.2% to 3% and most preferably at 0.5 to 2%. The film may also comprise an organic surfactant which may act not only to help disperse the other additives but also to act as a cell stabilizing agent. The organic surfactant is added at 0.05% to 4% of the total composition, preferably it is added at 0.1% to 2% and most preferably at 0.2 to 1%.

The particulars of the invention shown herein are by way of example. They are meant to illustrate various embodiments of the invention and not meant to limit the principles or concepts of the invention.

### EXAMPLE 1

A blowing agent additive masterbatch was produced using the following steps. 6.5 grams of sodium bicarbonate (USP Grade 5 from Church Dwight, 170-180 micron) is blended with 6.5 grams of citric acid (F4020 from Jungbunzlauer), 2.6 gram of behenamide was added with 49.4 gram of EVA resin(Ateva 2030) into a Brabender mixer. The blend was mixed for 1.5 minutes at 100° C. The melt was taken out and cold pressed into a sheet. The sheet is cut into pieces.

This blowing agent masterbatch is used for foaming a LDPE resin (Nova LFY-819A, 0.75 MI, 0.920 density) at a letdown ratio of 4%. These were added to a blown film extruder with the following characteristics; 42 mm screw diameter, 26:1 screw length to diameter ratio, 2.7″ outer diameter annular die with a 0.1″ (2.54 mm) dia gap. A foam with average cell size of 237.38 micron, foam bulk density 0.615 g/cm³ is made.

### EXAMPLE 2

A blowing agent additive masterbatch was prepared using the following steps. Sodium bicarbonate, USP Grade 1, 52.0 Micron, (Arm and Hammer), 16%, is mixed together with citric acid, F4020 (Jungbunzlaur), 4%, plus ethylene-bis-stearamide (Croda 212, Croda International), 4%, and 76% ethylene vinyl acetate co-polymer (Ateva 2030, AT Plastics). The blend was mixed for 1.5 minutes at 100° C. The melt was taken out and cold pressed into a sheet. The sheet is cut into pieces.

This blowing agent additive masterbatch is used for foaming a LDPE resin (Nova LFY-819A, 0.75 MI, 0.920 density) at a letdown ratio of 4%. These were added to a blown film extruder with the following characteristics; 42 mm screw diameter, 26:1 screw length to diameter ratio, 2.7″ outer diameter annular die with a 0.1″ (2.54 mm) dia gap. A foam with average cell size of 152 micron, foam bulk density 0.460 g/cm³ is made.

### EXAMPLE 3

A blowing agent additive masterbatch is prepared using the following steps. Sodium bicarbonate, USP Grade 1, 52.0 Micron, from Arm and Hammer is placed into a ball mill (United Nuclear 121b mill) together with stainless steel balls as the grinding media. This sodium bicarbonate, 16%, is mixed together with citric acid, F4020 (Jungbunzlaur), 4%, plus ethylene-bis-stearamide (Croda 212, Croda International), 4%, and 76% ethylene vinyl acetate co-polymer (Ateva 2030, AT Plastics). The blend was mixed for 1.5 minutes at 100° C. The melt was taken out and cold pressed into a sheet. The sheet is cut into pieces.

This blowing agent masterbatch is used for foaming a LDPE resin (Nova LFY-819A, 0.75 MI, 0.920 density) at a letdown ratio of 4%. These were added to a blown film extruder with the following characteristics; 42 mm screw diameter, 26:1 screw length to diameter ratio, 2.7″ outer diameter annular die with a 0.1″ (2.54 mm) dia gap. A foam with average cell size of 44 micron, foam bulk density 0.606 g/cm³ is made.

### EXAMPLE 4

A blowing agent additive masterbatch was prepared using the following steps. Sodium bicarbonate, USP Grade 1, 52.0 Micron, from Arm and Hammer was air-milled to reduce the particle size to an average of 6.5 microns. This sodium bicarbonate, 10%, was mixed together with citric acid, F4020 (Jungbunzlaur), 10%, plus ethylene-bis-stearamide (Croda 212, Croda International), 4%, and 76% ethylene vinyl acetate co-polymer (Ateva 2030, AT Plastics). The blend was mixed for 1.5 minutes at 100° C. The melt was taken out and cold pressed into a sheet. The sheet was cut into pieces.

This blowing agent additive masterbatch was used for foaming a LDPE resin (Nova LFY-819A, 0.75 MI, 0.920 density) at a letdown ratio of 4%. This was added to a blown film extruder with the following characteristics: 42 mm screw diameter, 26:1 screw length to diameter ratio, 2.7″ outer diameter annular die with a 0.1″ (2.54 mm) dia gap. A foam with average cell size of 25.3 micron, foam bulk density 0.606 g/cm³ was made. It was extruded to film with average thickness of 2.7 mil.

### EXAMPLE 5

A blowing agent additive pellet was prepared using the following steps. Sodium bicarbonate, USP Grade 1, 52.0 Micron, from Arm and Hammer was blended with 0.1% of a synthetic amorphous fumed silica (Cabosil M-5, Cabot Corp.) and this blend was air-milled to reduce the particle size. This ground sodium bicarbonate, 34.5%, was mixed together with citric acid, F4020 (Jungbunzlaur), 34.5%, plus 27.6% behenamide (Croda BR, Croda International), and 3.4% polyethylene glycol (Carbowax 300, Dow Chemical Corp.). This mixture was tumble blended and processed on a California Pellet Mill to form a blowing agent additive pellet.

These blowing agent additive pellets were used for foaming a LDPE resin (Nova LFY-819A, 0.75 MI, 0.920 density) at a letdown ratio of 1.0%. These were added to a blown film extruder with the following characteristics; 42 mm screw diameter, 26:1 screw length to diameter ratio, 2.7″ outer diameter annular die with a 0.1″ (2.54 mm) die gap. A foam with average cell size of 28.5 micron, foam bulk density 0.68.1 g/cm³ was made.

These blowing agent additive pellets are used for foaming a LDPE resin (Nova LFY-819A, 0.75 MI, 0.920 density) at a letdown ratio of 1.5%. These were added to a blown film extruder with the following characteristics; 42 mm screw diameter, 26:1 screw length to diameter ratio, 2.7″ outer diameter annular die with a 0.1″ (2.54 mm) die gap. A foam with average cell size of 32.5 micron, foam bulk density 0.674 g/cm³ is made.

### EXAMPLE 6

A blowing agent additive masterbatch was prepared using the following steps. Sodium bicarbonate, USP Grade 1, 52.0 Micron, from Arm and Hammer was air-milled to reduce the particle size to an average of 6.5 microns. 6.5 grams of this sodium bicarbonate is blended with 6.5 grams of citric acid (F4020 from Jungbunzlauer), 2.6 gram of behenamide was added with 49.4 gram of EVA resin( Ateva 2030) into a Brabender mixer. The blend was mixed for 1.5 minutes at 100° C. The melt was taken out and cold pressed into a sheet. The sheet was cut into pieces.

This blowing agent additive masterbatch was used for foaming a polystyrene resin (EA3300, high heat crystal polystyrene from Chevron Phillips, melt flow 1.8 g/10 min, 1.03 density) on a blown film extruder as described in Example 1 at a letdown ratio of 4%. A foam with average cell size of 19 micron and foam density of 0.698 g/cm³ was made.

### EXAMPLE 7

A blowing agent additive masterbatch was prepared using the following steps. Sodium bicarbonate, USP Grade 1, 52.0 Micron, from Arm and Hammer was air-milled to reduce the particle size to an average of 6.5 microns. 6.5 grams of this sodium bicarbonate was blended with 6.5 grams of citric acid (F4020 from Jungbunzlauer), 2.6 gram of behenamide was added with 49.4 gram of EVA resin( Ateva 2030) into a Brabender mixer. The blend was mixed for 1.5 minutes at 100° C. The melt was taken out and cold pressed into a sheet. The sheet was cut into pieces.

The blowing agent masterbatch was used for foaming a high density polyethylene resin (Sclair HD 19C, from Nova, 0.95 MI, 0.958 density) on a blown film extruder as described in Example 1 at a letdown ratio of 4%. A foam with average cell size of 54 micron, foam bulk density 0.612 g/cm³ was made. Film thickness was 4.8 mils.

### EXAMPLE 8

A blowing agent additive pellet was prepared using the following steps. Sodium bicarbonate, USP Grade 1, 52.0 Micron, from Arm and Hammer was blended with 0.1% of a synthetic amorphous fumed silica (Cabosil M-5, Cabot Corp.) and this blend was air-milled to reduce the particle size. This ground sodium bicarbonate, 34.5%, is mixed together with citric acid, F4020 (Jungbunzlaur), 34.5%, plus 27.6% behenamide (Croda BR, Croda International), and 3.4% polyethylene glycol (Carbowax 300, Dow Chemical Corp.). This mixture was tumble blended and processed on a California Pellet Mill to form a blowing agent additive pellet.

The blowing agent additive pellet was used for foaming a LDPE resin (Nova LFY-819A, 0.75 MI, 0.920 density) at a letdown ratio of 1.5% of the LDPE. Also, 1% of a nanoclay masterbatch (Nanofil 1450, Sud-Chemie) consisting of 50% nanoclay (Nanofil SE3000, Sud-Chemie) in an EVA carrier resin, was added. These were added to a blown film extruder with the following characteristics; 42 mm screw diameter, 26:1 screw length to diameter ratio, 2.7″ outer diameter annular die with a 0.1″ (2.54 mm) dia gap. A foamed film with average cell size of 54.3 micron with a film thickness of 4.9 mil was produced.

### EXAMPLE 9

A blowing agent additive pellet was prepared using the following steps. Sodium bicarbonate, USP Grade 1, 52.0 Micron, from Arm and Hammer was blended with 0.1% of a synthetic amorphous fumed silica (Cabosil M-5, Cabot Corp.) and this blend was air-milled to reduce the particle size. This ground sodium bicarbonate, 34.5%, was mixed together with citric acid, F4020 (Jungbunzlaur), 34.5%, plus 27.6% behenamide (Croda BR, Croda International), and 3.4% polyethylene glycol (Carbowax 300, Dow Chemical Corp.). This mixture was tumble blended and processed on a California Pellet Mill to form a blowing agent additive pellet.

The blowing agent pelletized additive blend was used for foaming a LDPE resin (Nova LFY-819A, 0.75 MI, 0.920 density) at a letdown ratio of 1.5% of the LDPE. Also, 1% of a nanoclay masterbatch consisting of 40% nanoclay in an EVA carrier resin, was added These were added to a blown film extruder with the following characteristics; 42 mm screw diameter, 26:1 screw length to diameter ratio, 2.7″ outer diameter annular die with a 0.05″ (1.27 mm) dia gap. A foamed film with average cell size of 42.6 micron with a film thickness of 4.1 mil was produced.

### EXAMPLE 10

A blowing agent additive pellet was prepared using the following steps. Sodium bicarbonate, USP Grade 1, 52.0 Micron, from Arm and Hammer was blended with 0.1% of a synthetic amorphous fumed silica (Cabosil M-5, Cabot Corp.) and this blend was air-milled to reduce the particle size. This ground sodium bicarbonate, 34.5%, was mixed together with citric acid, F4020 (Jungbunzlaur), 34.5%, plus 27.6% behenamide (Croda BR, Croda International), and 3.4% polyethylene glycol (Carbowax 300, Dow Chemical Corp.). This mixture was tumble blended and processed on a California Pellet Mill to form a blowing agent additive pellet.

The blowing agent pelletized additive blend was used for foaming a LDPE resin (Nova LFY-819A, 0.75 MI, 0.920 density) at a letdown ratio of 1.0% of the LDPE. Also, 2.5% of a talc masterbatch consisting of 40% talc (Jetfill 700C, Luzenac) in a LDPE (Nova LFY-819A, 0.75 MI, 0.920 density) carrier resin, was added. These were added to a blown film extruder with the following characteristics; 42 mm screw diameter, 26.1 screw length to diameter ratio, 2.7″ outer diameter annular die with a 0.05″ (1.27 mm) dia gap. A foamed film with average cell size of 23.6 micron with a film thickness of 3.5 mil was produced.

### REFERENCES CITED

The following U.S. Patent documents and publications are hereby incorporated by reference.

### US PATENT DOCUMENTS

U.S. Pat. No. 4,251,584 to van Engelen, et al.
U.S. Pat. No. 6,103,153 to Park, et al.
U.S. Pat. No. 4,251,584 to van Engelen, et al.
U.S. Pat. No. 6,521,675 to Wu, et al.

### OTHER PUBLICATIONS

Polymeric Foams and Foam Technology, 2^{nd} Edition, Edited by Daniel Klempner and Vahid Sendijarevic, Hanser Publishers, Munich 2004

What is claimed is:

1. A blowing agent masterbatch for foaming a polymeric resin comprising:
a) an inorganic blowing agent;
b) an organic acid;
c) an organic surfactant; and
d) a low melt temperature carrier resin;
wherein the inorganic blowing agent, the organic acid, the organic surfactant, and the low melt temperature carrier resin have been blended in a mixer.

2. The blowing agent masterbatch of claim 1, wherein the blowing agent masterbatch is in pellet form.

3. The blowing agent masterbatch of claim 1, wherein the inorganic blowing agent is an endothermic chemical blowing agent.

4. The blowing agent masterbatch of claim 1, wherein the inorganic blowing agent is sodium bicarbonate.

5. The blowing agent masterbatch of claim 1, wherein the organic acid is selected from the group consisting of: citric acid, stearic acid, lactic acid, tartaric acid, oleic acid, phthalic acid, maleic acid, and any combination thereof.

6. The blowing agent masterbatch of claim 1, wherein the organic surfactant is selected from the group consisting of: behenamide, erucamide, oleamide, stearamide, oleyl palmitamide, stearyl erucamide, ethylene bis-stearamide, ethylene bis-oleamide, glycerol esters, and any combination thereof.

7. The blowing agent masterbatch of claim 1, wherein the low melt temperature carrier resin has a melting point range of about 40-105° C.

8. The blowing agent masterbatch of claim 1, wherein the low melt temperature carrier resin has a melting point range of less than about 100° C.

9. The blowing agent masterbatch of claim 1, wherein the low melt temperature carrier resin is selected from the group consisting of: vinyl acrylates, butyl acrylates, ethyl acrylates, methyl acrylates, polyolefins, and any combination thereof.

10. The blowing agent masterbatch of claim 1, wherein the blowing agent masterbatch comprises about 2-30 parts of the organic acid, about 1-20 parts of the organic surfactant, about 40-95 parts of the low melting point polymer carrier resin, and about 2-50 parts of the inorganic blowing agent.

11. The blowing agent masterbatch of claim 1, wherein the blowing agent masterbatch comprises about 5-20 parts of the organic acid, about 2-15 parts of the organic surfactant, about 60-90 parts of the low melting point polymer carrier resin, and about 5-20 parts of the inorganic blowing agent.

12. The blowing agent masterbatch of claim 1, wherein the blowing agent masterbatch comprises about 5-15 parts of the organic acid, about 2-10 parts of the organic surfactant, about 70-80 parts of the low melting point polymer carrier resin, and about 5-15 parts of the inorganic blowing agent.

13. The blowing agent masterbatch of claim 1, further comprising a cell stabilizer.

14. The blowing agent masterbatch of claim 1, further comprising a fine particle nucleating agent.

15. A blowing agent additive for foaming a polymeric resin comprising:
a) an inorganic blowing agent;
b) an organic acid; and
c) an organic surfactant.

16. The blowing agent additive of claim 15, further comprising a binder.

17. The blowing agent additive of claim 15, wherein the blowing agent additive is in pellet form.

18. The blowing agent additive of claim 15, further comprising a cell stabilizer.

19. The blowing agent additive of claim 15, further comprising a fine particle nucleating agent.

20. A foamed polymeric resin film comprising:
a) an effective amount of the blowing agent masterbatch of claim 1; and
b) a polymeric resin,
wherein the blowing agent masterbatch and the polymeric resin are mixed to give a foamed polymeric resin film.

21. A foamed polymeric resin film comprising:
a) an effective amount of the blowing agent additive of claim 15; and
b) a polymeric resin,
wherein the blowing agent additive and the polymeric resin are mixed to give a foamed polymeric resin film.

22. The foamed polymeric resin film of claim 21, wherein the polymeric resin comprises polyolefin, polystyrene, or a mixture thereof.

23. The foamed polymeric resin film of claim 21, wherein the polymeric resin comprises polyethylene.

24. The foamed polymeric resin film of claim 21, wherein the average cell size is less than about 60 micron in diameter.

25. The foamed polymeric resin film of claim 21, wherein the average cell size is less than about 50 microns in diameter.

26. The foamed polymeric resin film of claim 21, wherein the average cell size is less than about 30 microns in diameter.

27. The foamed polymeric resin film of claim 21, wherein the film thickness is less than about 10 mil.

28. The foamed polymeric resin film of claim 21, wherein the film thickness is less than about 6 mil.

29. The foamed polymeric resin film of claim 21, wherein the film thickness is less than about 4 mil.

30. The foamed polymeric resin film of claim 21, further comprising a cell stabilizer.

31. The foamed polymeric resin film of claim 21, further comprising a fine particle nucleating agent.

32. The foamed polymeric resin film of claim 21, wherein the fine particle nucleating agent is selected from the group consisting of: silica, precipitated silica, talc, calcium carbonate, precipitated calcium carbonate, mica, titanium dioxide, nanosized titanium dioxide, clay, nanoclay, metal stearates, carbon black, sodium aluminum silicate, aluminum oxide, or a mixture thereof.

33. A method for manufacturing a foamed polymeric resin film, comprising the steps of:
a) obtaining a blowing agent masterbatch, wherein the blowing agent masterbatch comprises an inorganic blowing agent, an organic acid, an organic surfactant, and a low melt temperature carrier resin; and
b) adding the blowing agent masterbatch to a polymeric resin to give the foamed polymeric resin film.

34. A method for manufacturing a foamed polymeric resin film, comprising the steps of:
a) obtaining a blowing agent additive, wherein the blowing agent additive comprises an inorganic blowing agent, an organic acid, and an organic surfactant; and
b) adding the blowing agent additive to a polymeric resin to give the foamed polymeric resin film.

35. The method of claim 34, wherein in the blowing agent additive further comprises a binder.

36. A method for producing a foamed polymeric resin film, comprising the steps of:
a) mixing an inorganic blowing agent, an organic acid, and an organic surfactant with a polymeric resin; and
b) extruding the foamed polymeric resin film in a continuous process.

37. A method for manufacturing a foamed polymeric resin film, comprising the steps of:
a) combining an inorganic blowing agent, an organic acid, and an organic surfactant, either sequentially or simultaneously, to give a blowing agent additive; and
b) adding the blowing agent additive to a polymeric resin to give the foamed polymeric resin film.

38. The method of claim 37, wherein a binder is also added sequentially or simultaneously.
